(19) United States
(12) Patent Application Publication
(10) Pub. No.: US 2004/0105027 A1
(43) Pub. Date: Jun. 3, 2004

(54) Imaging system

(76) Inventors: Hiroyuki Kawamura, Tokyo (JP); Hironori Hosino, Tokyo (JP); Takeshi Fukuda, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/614,089

(22) Filed: Jul. 8, 2003

(30) Foreign Application Priority Data
Jul. 12, 2002 (JP) P 2002-204186

(51) Int. Cl. H04N 5/235

(52) U.S. Cl. 348/362

(57) ABSTRACT

An imaging system according to the invention can switch the automatic exposure control and the double exposure control depending on the state of the intensity of the image and supply a sharp image by restraining the blooming even in the case of having a strong illuminant such as an oncoming headlamp at night as well as by preventing from flicker even in the case of having no strong illuminant. It includes an IR lamp for radiating an infrared ray forward, a CCD camera for taking an image in the forward direction and converting the image into an electric signal, and an image processing unit which can be switched between an automatic exposure control for continuously and periodically supplying the images at a predetermined cycle of the signal accumulating time of the CCD camera and a double exposure control for varying the signal accumulating time of the CCD camera at a predetermined cycle and continuously and periodically supplying the images of different light exposure amount, and the image processing unit switches the automatic exposure control and the double exposure control depending on the state of the intensity of the image.

### BACKGROUND OF THE INVENTION

1. Field of the Invention

The present invention relates to an imaging system using a CCD camera.

2. Description of the Related Art

The conventional imaging system includes, for example, that one as shown in FIG. 13. In FIG. 13, this system includes a CCD camera 101 as imaging means, a DSP (Digital Signal Processor) 103 as an image processing unit, and a CPU 105.

The CPU 105 is connected to the DSP 103 through a multiplexer 107, so as to receive a signal from a shutter-speed setting switch 109. The shutter-speed setting switch 109 can set the shutter speed for the ODD (odd number) field and the shutter speed for the EVEN (even number) field respectively. Namely, the set state of the shutter-speed setting switch 109 is read out by the CPU 105 and the shutter-speed set values of the respective fields are encoded and supplied. A field pulse signal shown in FIG. 14 is supplied from the DSP 103 and when the output signal is high, the shutter-speed set value on the EVEN side is supplied to an input terminal for shutter-speed setting of the DSP 103 through the multiplexer 107, while when it is low, the shutter-speed set value on the ODD side is supplied there. The imaging system as shown in FIG. 13 can set various shutter-speeds depending on the respective fields.

Generally, when taking an image with a CCD camera, at an automatic shutter-speed having the same shutter speed in the ODD fields as well as in the EVEN fields, when a strong and bright illuminant comes into the dark surroundings as shown in FIG. 15, the vicinity of the illuminant disappears due to the blooming (halation). FIG. 15 shows an image ahead of a car taken with an in-vehicle CCD camera, while illuminating the forward direction with an infrared ray from an IR lamp that is the infrared ray illuminating means, during the run at night. The vicinity of a bright illuminant such as an oncoming headlamp and an illumination of a gas station disappears owing to the blooming. This is because the automatic shutter speed controls the whole screen output in an average darkness. Although the shutter speed can be set higher so as to restrain the blooming (halation), the sight of the background is fully lost in this case, as shown in FIG. 16.

On the contrary, the control of FIG. 13 for changing the shutter speed in every field is a so-called double exposure control, and various shutter speeds are set depending on the respective fields. Thus, a bright image and a dark image are alternatively supplied; a portion invisible because of darkness can be seen in a bright image (in the ODD fields in this case) and a portion invisible because of blooming (halation) can be seen in a dark image (in the EVEN fields in this case).

The images of the respective fields are alternatively supplied and they can be displayed on a monitor as a sharp image as shown in FIG. 17.

In the above simple double exposure control, however, one of the fields is for the bright image and the other is for the dark image, which causes flicker on the monitor disadvantageously, resulted from the alternative display of the bright image and the dark images.

On the other hand, in the case of a screen of the same brightness on the whole without such a strong and bright illuminant, as shown in FIG. 18, the automatic exposure control works properly and a sharp image can be displayed on a monitor without flicker.

Accordingly, in the imaging system of always performing the double exposure control, the double exposure control would work and cause some flicker on a screen, in spite of under a situation capable of displaying a sharp image on a monitor according to the proper operation of the automatic exposure control.

The invention is to provide an imaging system capable of switching the automatic exposure control and the double exposure control depending on the intensity of an image.

### SUMMARY OF THE INVENTION

The imaging system according to the invention comprises infrared ray illuminating means for radiating an infrared ray, imaging means for taking an image of a place illuminated by the infrared ray illuminating means and converting the image into an electric signal, and image processor which can be switched between an automatic exposure control for continuously and periodically supplying images of the same light exposure amount at a predetermined cycle of signal accumulating time of the imaging means and a double exposure control for varying the signal accumulating time of the imaging means at a predetermined cycle and continuously and periodically supplying images of different light exposure amount, and the image processor switches the automatic exposure control and the double exposure control depending on a state of the intensity of the image.

In the imaging system according to the invention, the image processor switches the automatic exposure control to the double exposure control when a bright area of the image exceeds an intensity threshold as a reference of a bright image and the dimensions of the area exceed an area threshold as a reference of switching.

In the imaging system according to the invention, the image processor vertically extends the images of different light exposure amount and averages the signal levels of the both extended images, in the double exposure control, thereby forming a composite image.

In the imaging system according to the invention, the image processor inserts an average value of the signal levels of vertically adjacent pixels between the both pixels, thereby extending the images.

In the imaging system according to the invention, the infrared ray illuminating means, the imaging means, and the image processor are provided in a car, the infrared ray illuminating means illuminates an outside of the car with the infrared ray, and the imaging means takes an image of the outside of the car.

According to the invention, the infrared ray illuminating means can radiate the infrared ray. The imaging means can take an image of the place illuminated by the infrared ray illuminating means and convert the image into an electric signal. The image processor can switch the automatic exposure control and the double exposure control depending on the state of the intensity of the image. In the automatic exposure control, it is possible to continuously and periodically supply the images of the same light exposure amount at a predetermined cycle of the signal accumulating time of the imaging means. In the double exposure control, it is possible to vary the signal accumulating time of the imaging means at a predetermined cycle and continuously and periodically supply the images of different light exposure amount.

Accordingly, in the case of a screen having the uniform brightness on the whole with no strong and bright illuminant, the automatic exposure control can work properly, so to supply a sharp image without flicker. Under the circumstances where a strong and bright illuminant enters in the dark surroundings, the double exposure control can work, so to show a portion dark and invisible in a bright image as well as a portion invisible because of blooming (halation) in a dark image. Therefore, a sharp image output is possible.

According to the invention, the image processor can switch the automatic exposure control to the double exposure control when a bright area of the image exceeds the intensity threshold as a reference of a bright image and the dimensions thereof exceed the area threshold as a reference of switching. Accordingly, by using the intensity threshold and the area threshold, the automatic exposure control and the double exposure control can be properly switched.

Further, the image processor can extend the images of difference light exposure amount in a vertical direction and average the signal levels of the both extended images, in the double exposure control, thereby forming a composite image.

According to the double exposure control, it is possible to show the portion dark and invisible in a bright image as well as the portion invisible because of the blooming (halation) in a dark image and prevent boundary and flicker occurring on the output image due to a difference of the light exposure amount and supply a sharper image.

According to the invention, since the image processor extends the image by inserting the average value of the signal levels of the vertically adjacent pixels between the same pixels, it is possible to extend the images easily and supply a sharper image.

According to the invention, the infrared ray illuminating means, the imaging means, and the image processor can be provided in a car, the infrared ray illuminating means can illuminate an outside of the car with the infrared ray, and the imaging means can take an image of the outside of the car. Accordingly, in a situation without an oncoming headlamp and the like, it is possible to confirm the outside of the car thanks to the sharp image output, under the automatic exposure control. Under the double exposure control, it is also possible to confirm the above, by restraining the blooming (halation) due to an oncoming headlamp and the like and showing the dark portion brightly and sharply.

### BRIEF DESCRIPTION OF THE DRAWINGS

FIG. 1 is a schematic view of a car to which one embodiment of the invention is adopted.

FIG. 2 is a block diagram of imaging means and an image processor, according to the embodiment.

FIG. 3 is a flow chart, according to the embodiment.

FIG. 4 is a flow chart of shutter-speed switching, according to the embodiment.

FIG. 5A shows an image with no bright illuminant and FIG. 5B shows an image obtained by binarizing the image of A by the intensity threshold being set, according to the embodiment.

FIG. 6A shows an image with a bright illuminant and FIG. 6B shows an image obtained by binarizing the image of A by the intensity threshold being set, according to the embodiment.

FIG. 7 shows an area retrieval according to the embodiment; A is a schematic view of array initialization, B is a schematic view at a detecting time of a starting point, C is a schematic view at a time of extracting an outline, D is a schematic view at a time of filling the inside, E is a schematic view at a time of finishing the retrieval, and F is a schematic view showing the retrieval order.

FIG. 8 shows an output image according to the simple double exposure control, according to the embodiment.

FIG. 9A shows a divided image of the ODD fields and B shows a divided image of the EVEN fields, according to the embodiment.

FIG. 10A shows an extended image of the ODD fields and B shows an extended image of the EVEN fields, according to the embodiment.

FIG. 11A shows a quality-adjusted image of the ODD fields and B shows a quality-adjusted image of the EVEN fields, according to the embodiment.

FIG. 12 shows an average composite image formed, according to the embodiment.

FIG. 13 is a block diagram according to the conventional example.

FIG. 14 is an output view of a field pulse, according to the conventional example.

FIG. 15 is an output image view at the general shutter speed, according to the conventional example.

FIG. 16 is an output image view at a high shutter-speed, according to the conventional example.

FIG. 17 is an output image view showing the blooming (halation) phenomenon.

FIG. 18 is an output image view with no strong and bright illuminant, according to the conventional example.

### DESCRIPTION OF THE PREFERRED EMBODIMENT

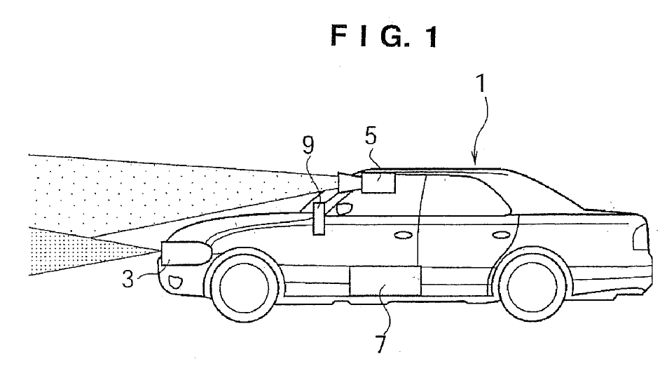

FIG. 1 to FIG. 12 show one embodiment of the invention.

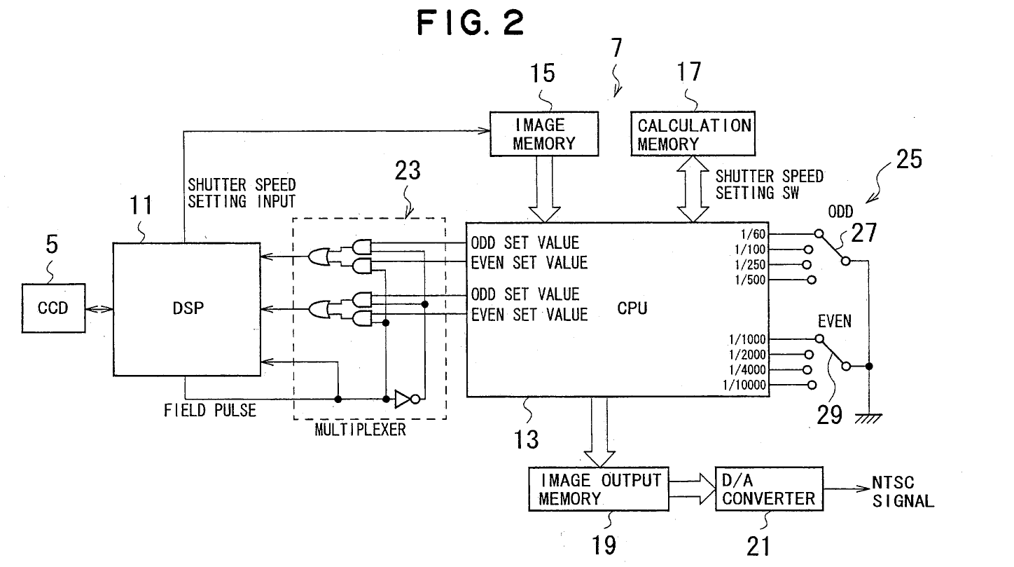

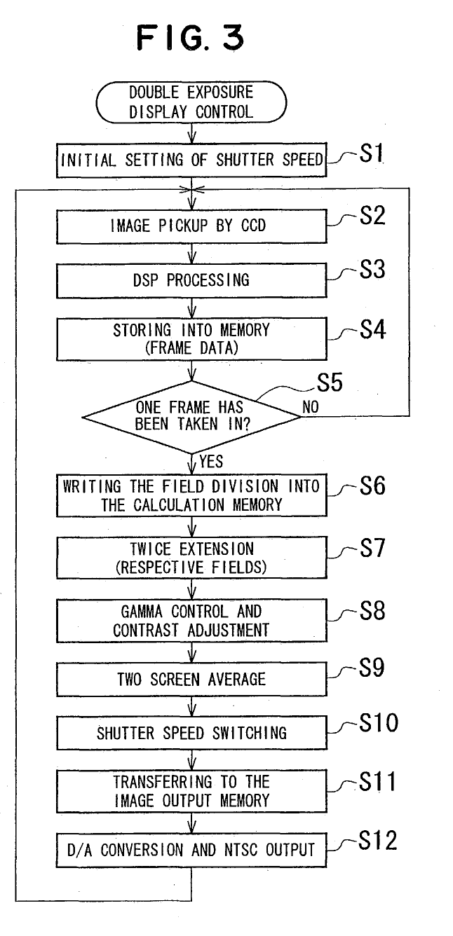

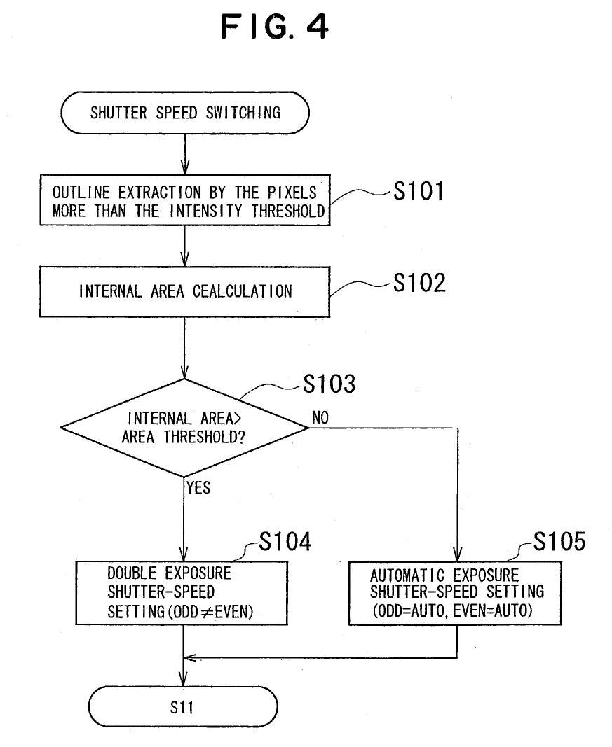

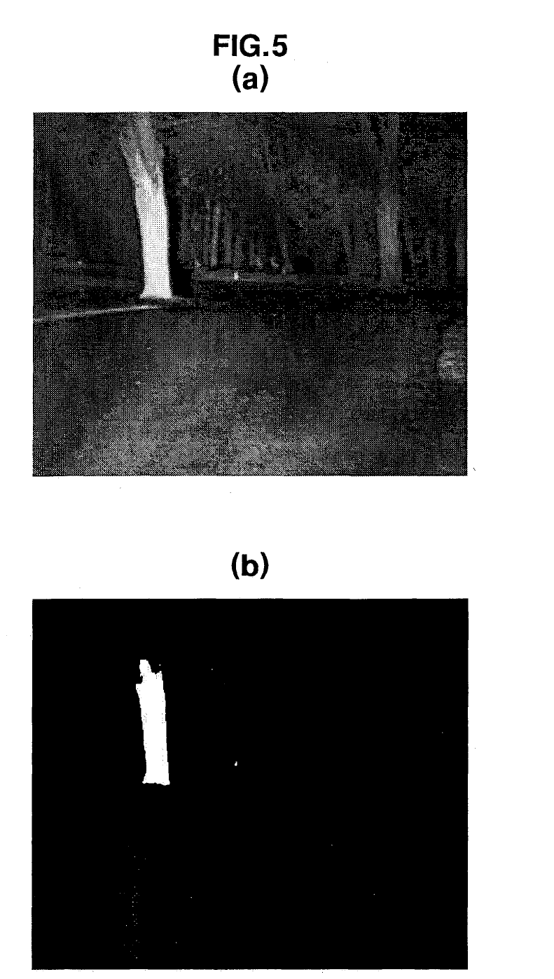

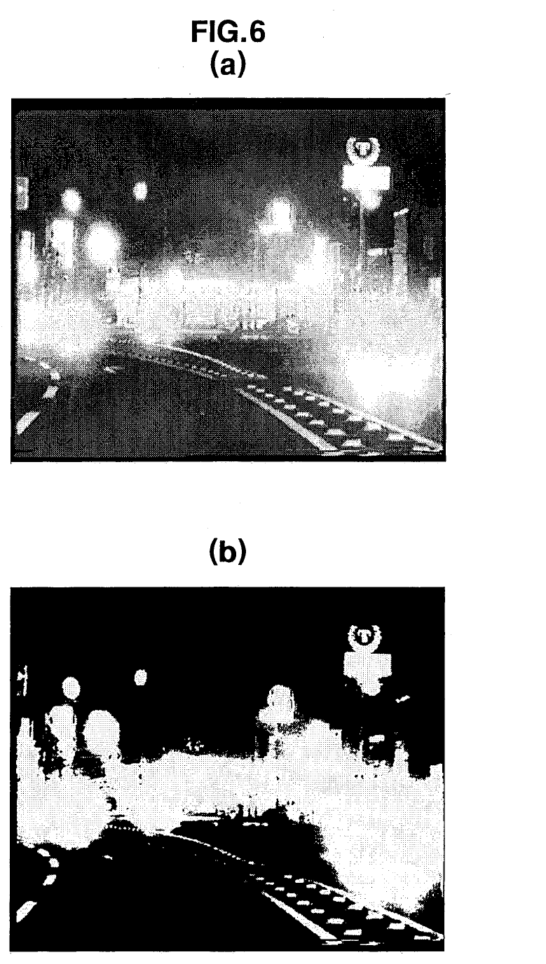

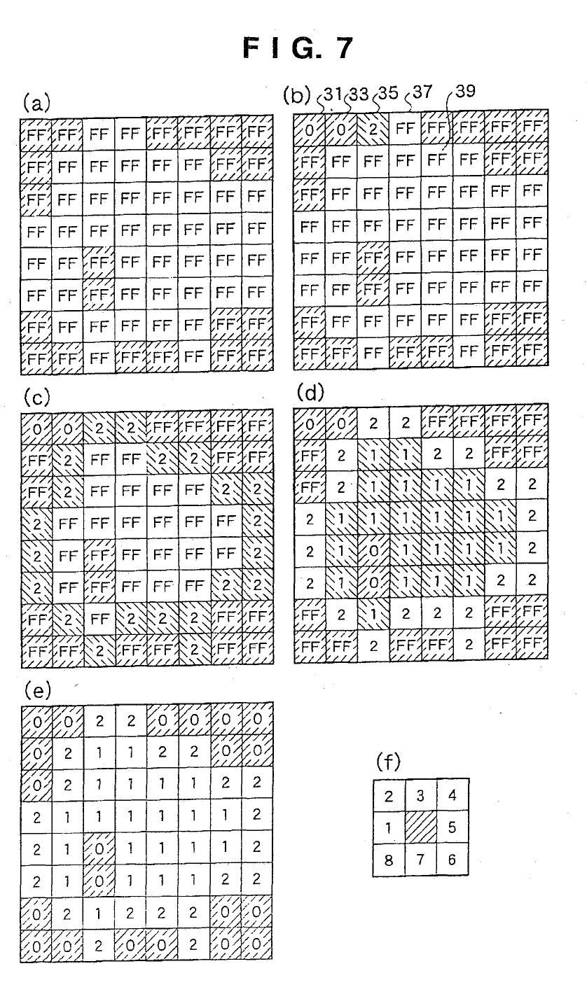

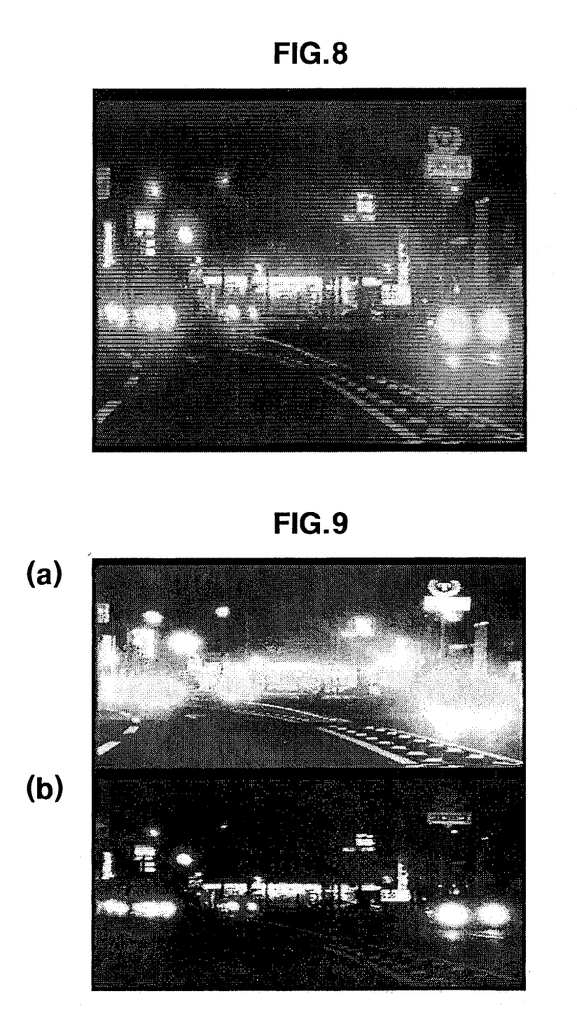

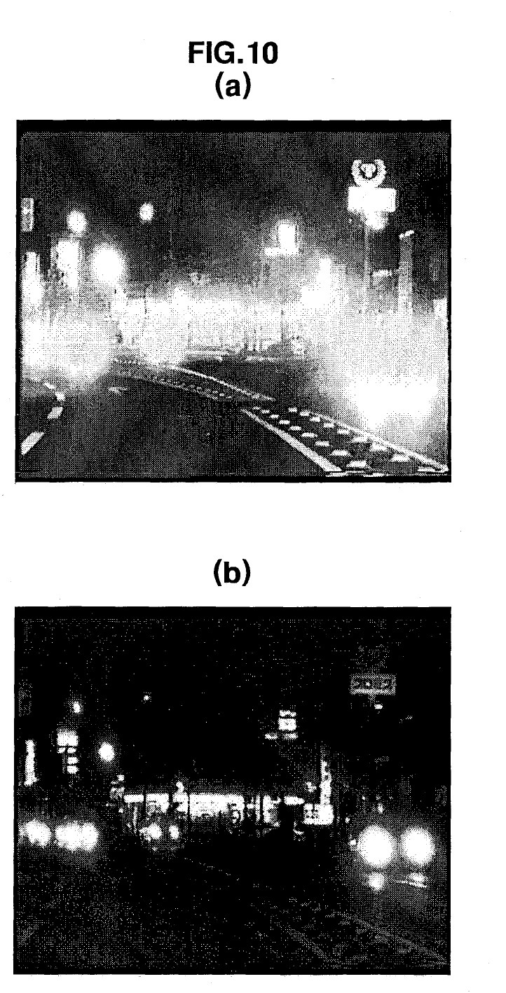

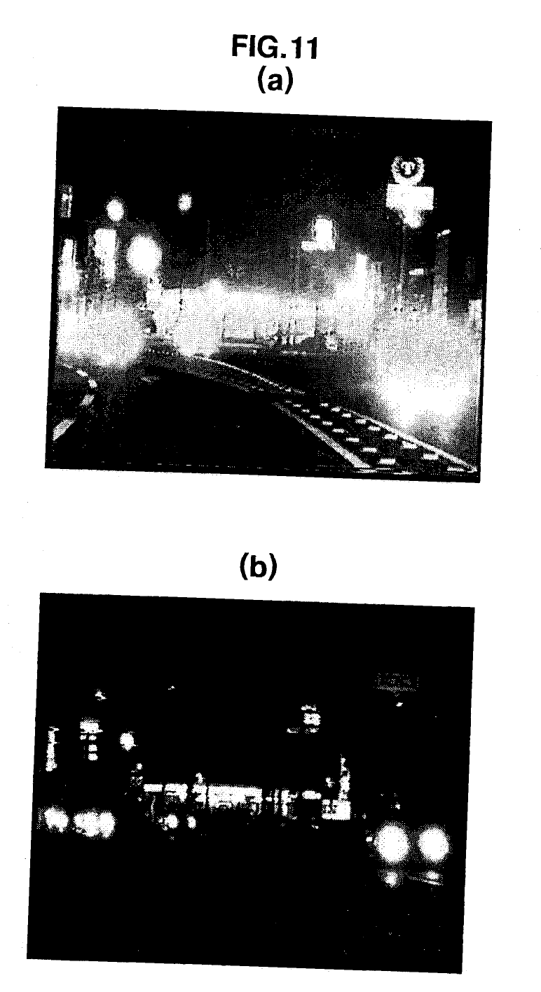

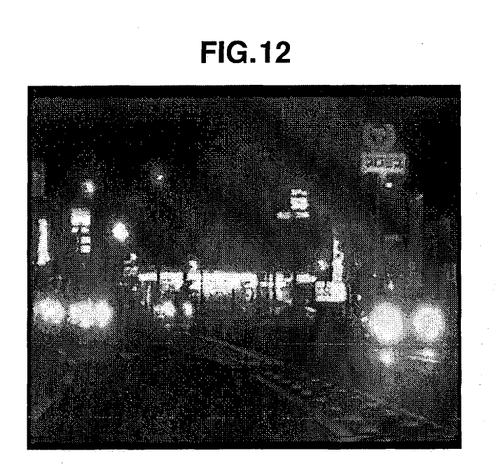

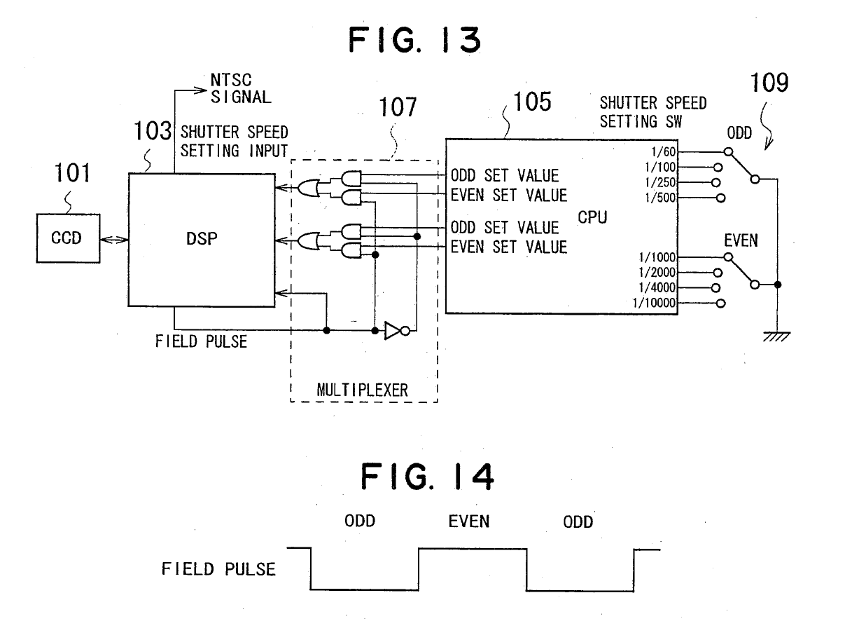

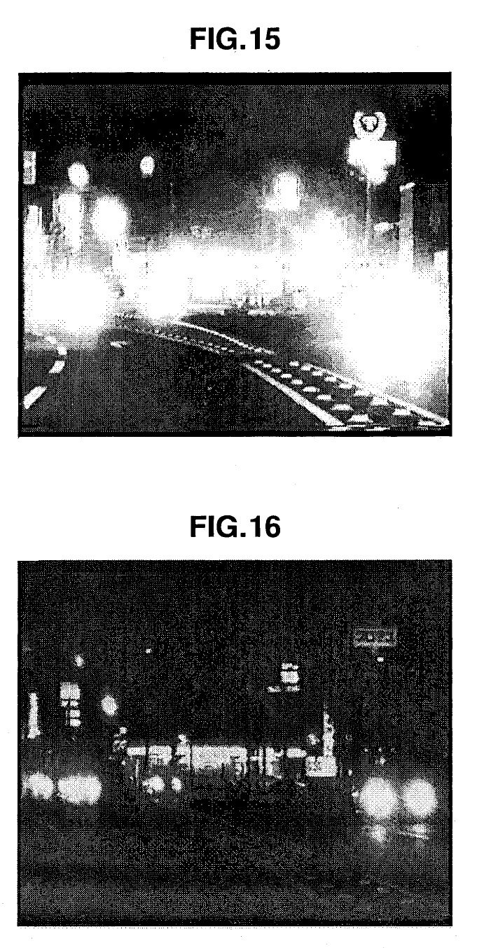

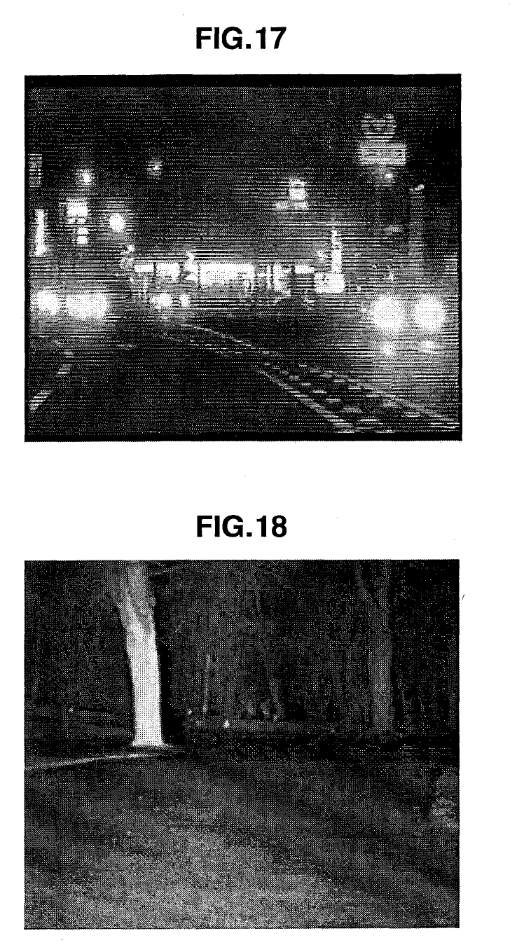

FIG. 1 is a schematic view of a car to which the embodiment of the invention is adopted, FIG. 2 is a block diagram showing imaging means and an image processor according to the embodiment, FIG. 3 is a flow chart according to the embodiment, and FIG. 4 is a flow chart of shutter speed switching. FIG. 5A shows an image without bright illuminant, and FIG. 5B shows an image obtained by binarizing the image of A by the intensity threshold being set. FIG. 6A shows an image with a bright illuminant and FIG. 6B shows an image obtained by binarizing the image of A by the intensity threshold being set. FIG. 7 shows an area retrieval; A is a schematic view of array initialization, B is a schematic view at a detecting time of a starting point, C is a schematic view at a time of extracting an outline, D is a schematic view at a time of filling the inside, E is a schematic view at a time of finishing the retrieval, and F is a schematic view showing the retrieval order. FIG. 8 shows an output image according to the simple double exposure control. FIG. 9 shows a field divided image; A shows a divided image of the ODD fields and B shows a divided image of the EVEN fields. FIG. 10 shows a field extended image; A shows an extended image of the ODD fields and B shows an extended image of the EVEN fields. FIG. 11 shows an image for adjusting the image quality of the fields; A shows a quality-adjusted image of the ODD fields and B shows a quality-adjusted image of the EVEN fields. FIG. 12 shows an average composite image.

As shown in FIG. 1, an imaging system according to one embodiment of the invention is to be applied to a car, and the car 1 comprises an IR lamp 3 as the infrared ray illuminating means, a CCD camera 5 as the imaging means, an image processing unit 7 as the image processor, and further a headup display 9.

The IR lamp 3 is to illuminate the forward direction ahead of the car 1 in the running direction with an infrared ray, in order to enable the camera to take an image at a dark place, for example, at night. The CCD camera 5 is to take an image ahead of the car 1 in the running direction, illuminated by the infrared ray, and to convert it into an electric signal. The electric signal in this case is to be converted by a photo diode of a photosensitive unit in the CCD camera 5.

The image processing unit 7 can be switched between the automatic exposure control for continuously and periodically supplying the images of the same light exposure amount at a predetermined cycle of the signal accumulating time of the CCD camera 5 and the double exposure control for varying the signal accumulating time of the CCD camera 5 at a predetermined cycle and continuously and periodically supplying the images of different light exposure amount. The image processing unit 7 can switch the automatic exposure control and the double exposure control according to the intensity of the image.

The signal accumulating time is a signal accumulating time for every pixel. The same light exposure amount at a predetermined cycle of the signal accumulating time means that the timing speed of reading out the signal charges accumulated for every pixel is set at the same speed in the ODD fields as well as the EVEN fields, and the shutter speed of the electronic shutter operation becomes identical in the ODD fields and the EVEN fields. In the automatic exposure control, the shutter speed is controlled depending on the brightness level. Continuously and periodically supplying the images of the same light exposure amount means that the images of the respective fields read out at the respectively same shutter speeds are continuously and alternatively supplied in every 1/60 sec.

Varying the signal accumulating time at a predetermined cycle means that by varying the number of the pulses discharging the unnecessary electric charges accumulated in every pixel, the time accumulated is varied as a result and it means the electronic shutter operation. Continuously and periodically supplying the images of different light exposure amount means that the shutter speed is set for every field of the ODD and the EVEN, according to the electronic shutter operation and that the images of the respective fields read out at the respective shutter speeds are continuously and alternatively supplied in every 1/60 sec.

In the high speed shutter in which the shutter speed is fast, a dark portion is difficult to show but a bright portion can be seen sharply, while in the low speed shutter in which the shutter speed is slow, a bright portion is saturated and blown out but a dark portion can be seen sharply.

The image processing unit 7 extends the images of different light exposure amount longitudinally and averages the signal levels of the both extended images, hence to form a composite image, at a time of double exposure control in the embodiment.

Extending the images of different light exposure amount longitudinally means that the divided image of the ODD field and the divided image of the EVEN field obtained as the images of different light exposure amount by varying the shutter speed in the embodiment are respectively extended twice in a longitudinal direction. Averaging the signal levels of the both extended images, hence to form a composite image means that the signal levels of the corresponding pixels are averaged, in the divided images of the respective fields after extension, hence to supply one image.

As illustrated in FIG. 2, the image processing unit 7 comprises an image memory 15, a memory 17 for calculation, a memory 19 for image output, and a D/A converter 21, in addition to a DSP 11 and a CPU 13. The image processing unit 7 includes a multiplexer 23 and a shutter-speed setting switch 25 in order to change the shutter speed. The shutter speed setting switch 25 has an ODD switch 27 and an EVEN switch 29.

The DSP 11 is to convert a signal from the CCD camera 5 into a digital signal.

The CPU 13 is to perform various calculations and to control each shutter speed for the ODD field and the EVEN field under the double exposure control. Namely, the setting states of the ODD switch 27 and the EVEN switch 29 of the shutter-speed setting switch 25 are read out by the CPU 13 and the shutter speed set values of the respective fields are encoded and supplied. A field pulse signal of FIG. 14 is supplied from the DSP 11; when the output signal is high, the shutter speed set value on the EVEN side is supplied to the input terminal for the shutter speed setting of the DSP 11 through the multiplexer 23, while when the output signal is low, the shutter speed set value on the ODD side is supplied there. Accordingly, it is possible to set the shutter speed different in every field.

The CPU 13 switches the automatic exposure control and the double exposure control according to the intensity of the frame image data taken by the image memory 15. Namely, it switches the automatic exposure control to the double exposure control when a bright area on the image data exceeds the intensity threshold that is a reference for a bright image and the area exceeds the area threshold that is a reference for switching.

The image memory 15 is to store the image data for one frame to be supplied from the DSP 11.

In the automatic exposure control, the frame image data stored in the image memory 15 is transferred to the memory 19 for image output, as it is, converted into analog data by the D/A converter 21, and supplied as, for example, an NTSC signal.

In the double exposure control, the frame image data stored in the image memory 15 is divided into every ODD field and EVEN field and written in the memory 17 for calculation. The CPU 13 longitudinally extends the respective field images written in the memory 17 for calculation twice and image adjustment such as gamma control and contrast adjustment is performed on the respective extended images. These two image data are averaged, the composite image data after averaging is transferred to the memory 19 for image output, converted into analog data by the D/A converter 21, and supplied as, for example, an NTSC signal.

FIG. 3 shows a flow chart of the embodiment. According to the flow chart of FIG. 3, at first, in Step S1, the processing of “initial setting of the shutter speed” is performed. In Step S1, the shutter speed for the double exposure control is set. In this embodiment, for example, the shutter speed on the side of the ODD field is set low as mentioned above, and the shutter speed on the side of the EVEN field is set high.

In this embodiment, the shutter speed on the side of the ODD field is set at 1/60 sec. and the shutter speed on the side of the EVEN field is set at 1/1000 sec. and the operation proceeds to Step S2. The respective shutter speeds may take the other values than the above. Alternatively, the side of the ODD field may be set at the high shutter speed and the side of the EVEN field may be set at the low shutter speed.

In Step S2, the processing of “CCD imaging” is performed. In Step S2, the shutter speed control signal on the side of the ODD field and the shutter speed control signal on the side of the EVEN field which have been set in Step S1 are supplied from the CPU 13 to the DSP 11.

Then, the CCD camera 5 takes an image according to the driving signal and the signal charge is performed on the whole pixels of the photo diode of the photosensitive unit of the CCD camera 5. On the side of the ODD field, the signal charge of each pixel of the odd number vertically in every other line is read out at 1/60 sec., of the whole pixels of the photo diode of the photosensitive unit. On the side of the EVEN field, the signal charge of each pixel of the even number is read out at an accumulating time of 1/1000 sec. and the operation proceeds to Step S3.

In Step S3, the processing of “DSP” is performed. In Step S3, the signal charge read out by the CCD camera 5 is taken in, converted into digital signal by the A/D converter, subjected to signal processing and output, and the operation proceeds to Step S4.

In Step S4, the processing of “storing into memory” is performed and the processed signal supplied from the DSP 11 is stored into the image memory 15, and the operation proceeds to Step S5.

In Step S5, the processing for “checking whether one frame has been taken or not” is performed and it is judged whether one frame of the processed signal supplied from the DSP 11 is stored into the image memory 15. When one frame is not stored into the image memory 15, the operation is returned to Step S2, and thereafter, the processing of Step S3, Step S4, and Step S5 is repeated. In Step S5, when it is judged that one frame of the processed signal has been stored, the operation proceeds to Step S6.

In Step S6, the processing of “writing the field division into the calculation memory” is performed. In Step S6, the frame image data stored into the image memory 15 by the CPU 13 is divided into every ODD field and the EVEN field, written into the calculation memory 17, and the operation proceeds to Step S7. The image data of every ODD field and EVEN field written into the calculation memory 17 is the data in every other line in a longitudinal direction, and therefore it becomes the image data longitudinally compressed in a half.

In Step S7, the processing of “twice extension” is performed, and the image data of the ODD fields and the EVEN fields written in the calculation memory 17 are vertically extended twice. As the extension method in this case, there are a method of extending one pixel of every field to two pixels in a vertical direction and a method of averaging the signal levels of the two pixels vertically aligned and inserting the above average value between the two pixels vertically aligned.

In Step S8, the processing of “gamma control and contrast adjustment” is performed, the image adjustment such as gamma control and contrast adjustment is performed on the respective extended screens in Step S7, and the operation proceeds to Step S9.

In Step S9, the processing of “two screen average” is performed, and the image data of the ODD fields and the EVEN fields vertically extended twice are averaged. Here, the signal levels of the respective pixels corresponding to the ODD fields and the EVEN fields are averaged by simple average, the image data for one new frame is formed according to the respective signal levels averaged. Thus, an image composed by the image data extended twice in the respective fields is formed, and the operation proceeds to Step S10.

In Step S10, the processing of “shutter speed switching” is performed, the automatic exposure control and the double exposure control are switched according to the intensity of the frame image data taken in the image memory 15, and the operation proceeds to Step S11.

In Step S11, the processing of “transfer to the image output memory” is performed, the frame image data stored into the image memory 15 is transferred to the image output memory 19 as it is, in the automatic exposure control, and the operation proceeds to Step S12. In the double exposure control, the composite image data is transferred to the image output memory 19, and the operation proceeds to Step S12. The above processing is not always performed in a time-sharing way, but the output from the output memory is always performed even while storing into the image memory. Also while the data stored in the image memory is processed, the image signal of the next frame is continuously being taken in.

In Step S12, the processing of “D/A conversion, NTSC output” is performed, the digital signal of the image data is converted into analog signal by the D/A converter 21, and supplied, for example, as an NTSC signal.

The “shutter speed switching” in Step S10 is performed according to the flow chart of FIG. 4. When the flow chart of FIG. 4 is carried out, the processing of “outline extraction by the pixels more than the intensity threshold” is performed in Step S101. In Step S101, a pixel which exceeds the intensity threshold as a reference of a bright image, is detected, in the image data for one frame stored in the image memory 15, the outline of the area exceeding the intensity threshold with reference to this pixel is extracted, and the operation proceeds to Step S102.

In Step S102, the processing of “internal area calculation” is performed, the number of internal pixels within the extracted outline is counted and the area is calculated, and the operation proceeds to Step S103. Here, the number of pixels is substituted for the area.

In Step S103, the processing of “internal area>area threshold” is performed, and it is checked whether the above calculated internal area exceeds the area threshold as a reference of switching. When the internal area exceeds the area threshold (YES), the operation proceeds to Step S104, while when it does not exceed it (NO), the operation proceeds to Step S105.

In Step S104, the processing of “double exposure shutter-speed setting” is performed. It is judged that there exists a stronger and brighter illuminant than a predetermined value, and the control is switched to the double exposure control. Namely, the output of the shutter speed set value initially set in Step S1 as mentioned above is supplied to the input terminal for shutter speed setting of the DSP 11 by the multiplexer 23. In Step S104, the shutter speed for the initial setting can be set newly. For example, a plurality of shutter speeds are provided in the respective fields and depending on the intensity value of the image data within the image memory 15, each shutter speed can be adjusted.

In Step S105, the processing of “automatic exposure shutter-speed setting” is performed, and when there exists no stronger and brighter illuminant than a predetermined value and it is evenly dark on the whole, the control is switched to the automatic exposure control. Namely, the automatic exposure shutter speed set value (ODD=AUTO, EVEN=AUTO) is supplied to the DSP 11. In this case, since there is no bright illuminant, both the shutter speeds in the ODD fields and the EVEN fields are set at 1/60 sec. of the low shutter speed, so as to get a sharp image of the whole dark circumstances. This shutter speed is controlled so as to vary depending on the brightness level as mentioned above, for example, the intensity value of the image data within the image memory 15.

During the double exposure control, the processing of Steps S101 to S103 will be performed on a bright field with low shutter speed, that is, in this embodiment, the image data of the ODD field.

The optimum parameters are determined after experimental estimation, as for the intensity threshold and the area threshold in Step S101 and Step S103.

The image with no stronger and brighter illuminant than a predetermined value of FIG. 5A is binarized by, for example, the intensity threshold 200, into the image as shown in FIG. 5B. The image with a stronger and brighter illuminant than a predetermined value, as shown in FIG. 6A, is binarized by the intensity threshold 200, into the image as shown in FIG. 6B.

Apparent from a comparison between FIG. 5B and FIG. 6B, the area of a bright portion (white) is obviously different. By setting the area threshold between these tow area values (the number of pixels), the flow chart of FIG. 4 can be performed.

The outline extraction in Step S101 is performed, for example, like in FIGS. 7A, B, and C, and the internal area calculation in Step S102 is performed like in FIGS. 7D and E. In FIG. 7A, in order to make an easy understanding, when it exceeds the intensity threshold, it is shown as a hollow square and when it is below the intensity threshold, it is shown as a shaded square slanting up on the right.

(Outline Extraction)

At first, as shown in FIG. 7A, the arrays of the pixels of the area large enough to include a bright area are read in order to extract the bright area, and initially 0×FF is substituted in each array.

As illustrated in FIG. 7B, a pixel having the intensity exceeding the intensity threshold is horizontally retrieved from the top left within the area. The value 0 is substituted into the array of a pixel having the intensity below the intensity threshold. In FIG. 7B, 0 is substituted into the arrays 31 and 33, but when detecting a pixel having the intensity exceeding the intensity threshold, another label is attached to the array of the corresponding position. In FIG. 7B, a label 2 is attached to the array 35. With this array 35 as a reference point, as described in FIG. 7F, a pixel exceeding the intensity threshold is retrieved clockwise, starting from the left pixel, the label 2 is attached to the array of the pixel exceeding the intensity threshold, and the outline is extracted after making a round as shown in FIG. 7C. Simultaneously, the number of the labels 2 is counted.

(Filling the Inside)

Next, the other labels are attached to the inside of the outline extracted area as shown in FIG. 7C so as to exclude the above portion at the next extraction of the area. Here, the labels 2 are detected at the both ends of the extracted area horizontally in every other line, and the label 1 of one smaller than the above label is attached to each pixel among the above pixels, exceeding the intensity threshold, as shown in FIG. 7D. Simultaneously, the number of the labels 1 is counted.

In this way, the outline is distinguished from the inside, in order to make the bordering of the bright area easy and when there is no necessity to distinguish the both, the same values can be attached there.

In the case of a pixel below the intensity threshold even within the bright area, the value 0 meaning the pixel to end is substituted to the array of the pixel. Similarly, as shown in FIG. 7E, 0 is substituted also in the array requiring no retrieval because of existing in the outside of the outline, so as to exclude the above from the retrieval area.

(Area Calculation)

The value obtained by adding the number of the labels 2 of the outline and the number of the labels 1 of the inside is regarded as the dimensions of the bright area, namely the number of the pixels of the bright area.

The retrieval of the pixel having the intensity more than the intensive threshold is performed in the numeric order of FIG. 7F. Namely, the retrieval is sequentially performed horizontally from the top left within the area, and for example, in FIG. 7B, since the arrays 31 and 33 are both the pixels below the intensity threshold, 0 is sequentially substituted in the arrays while transferring the center of the retrieval.

When the center of the retrieval moves to the array 33, assuming that the array 33 is positioned at the center of FIG. 7F, the arrays around are retrieved clockwise from the number 1 to the number 8. In this case, since there are no arrays in FIG. 7B corresponding to the numbers 2, 3, and 4 of FIG. 7F, the retrieval is actually performed from the number 5. In the retrieval of the array 33, the array 35 corresponding to the number 5 is detected as the pixel exceeding the intensity threshold and the label 2 is substituted in the array 35 as shown in FIG. 7B.

The center of the retrieval moves to the array 35, and assuming that the array 35 is positioned at the center of FIG. 7F, the retrieval is similarly performed from the number 1 to the number 8. Also in this case, since there are no arrays in the numbers 2, 3, and 4, the retrieval is performed from the number 5. In this case, since the array 37 adjacent to the array 35, which is detected as the number 5, is the pixel exceeding the intensity threshold, the label 2 is substituted there as shown in FIG. 7C.

The center of the retrieval moves to the array 37, and assuming that the array 37 is positioned at the center of FIG. 7F, the retrieval is similarly performed from the number 1 to the number 8. Similarly, the numbers 2 to 4 are cancelled and the retrieval is performed from the number 5, the pixel exceeding the intensity threshold is detected on the number 6, and as shown in FIG. 7C, the label 2 is substituted in the array 39 shown in FIG. 7B.

Since the pixel of the array adjacent to the array 37 on the right side is below the intensity threshold, it is judged that the further horizontally retrieval is not necessary in order to extract the outline and the center of the retrieval immediately moves to the array 39.

The same retrieval is performed in these ways, and as illustrated in FIG. 7C, the outline obtained by the labels 2 substituted can be extracted.

According to the above processing, the signal supplied from the image processing unit 7 is supplied to the headup display 9 indicated in FIG. 1. The headup display 9 can display the image on a front window glass and it enables a driver of the car 1 to grasp the situation forward of the vehicle properly even in a dark place, for example, at night, by confirming the above image.

Accordingly, in the case of a screen having the uniform brightness on the whole with no stronger and brighter illuminant than a predetermined value, the automatic exposure control can be properly worked so as to get a sharp image output like FIG. 18. Therefore, it is possible to prevent from such an improper control that the double exposure control would work, in spite of the situation capable of displaying a sharp image on a monitor under the properly working automatic exposure control, and to properly restrain screen flicker caused by a difference of the light exposure amount.

In a situation where a stronger and brighter illuminant than a predetermined value is entered into dark surroundings, the control is switched to the double exposure control, the portion dark and invisible in a bright image and the portion invisible by the blooming (halation) in a dark image can be both shown and a sharper image can be supplied.

When it is switched to the double exposure control, the processing of the image data as shown in FIG. 8 to FIG. 11 is performed according to the processing by the flow chart of FIG. 3, and the image as shown in FIG. 12 can be displayed by the headup display 9.

The image of FIG. 8 is the image data for one frame taken into the image memory 15 according to the double exposure control through the processing from Step S1 to Step S5. The image data of FIG. 8 is divided into the image data of the ODD fields in FIG. 9A and the image data of the EVEN fields in FIG. 9B, according to the field division of Step S6. In the ODD fields where the shutter speed is slow, a bright portion is saturated and blown out but a dark portion can be seen sharply, while in the EVEN fields where the shutter speed is fast, a dark portion is difficult to show but a bright portion can be seen sharply.

The divided image data of FIG. 9 is extended twice like in Step S7, hence to obtain the extended image of the ODD fields in FIG. 10A and the extended image of the EVEN fields in FIG. 10B. The gamma control and the contrast adjustment of Step S8 are performed on the respective extended images, hence to obtain the quality-adjusted data of the ODD fields in FIG. 11A and the quality-adjusted data of the EVEN fields in FIG. 11B.

By averaging the both screens in Step S9, or by averaging the signal levels of the both images after extension as mentioned above, the composite image is formed and the image as shown in FIG. 12 is supplied.

The output image of FIG. 12 obviously becomes much sharper than the output image simply according to the double exposure control of FIG. 8. By restraining properly the blooming (halation) caused by a strong oncoming headlight, not only the information in the vicinity of the illuminant can be shown but also the dark portion can be more sharply shown on the whole.

As mentioned above, the simple double exposure control of FIG. 8 only supplies the images of different light exposure amount continuously and periodically, which causes flicker shown in FIG. 8 as the output image. On the contrary, according to the embodiment of the invention, the image is divided into every ODD fields and EVEN field, a composite image is formed by averaging the signal levels of the both extended images, and therefore, a sharper image as shown in FIG. 12 can be supplied.

The output image of FIG. 12 is formed by the composition, after averaging the signal levels. Therefore, the above image has no boundary and it can be supplied more sharply with no flicker, compared with the case of partially composing the images of different light exposure amount.

Thus, under a situation without an oncoming headlamp, the automatic exposure control enables a driver to confirm the situation forward of the car by the sharp image output. The double exposure control can show a dark portion brightly and sharply while restraining the blooming (halation) owing to an oncoming headlamp and it also enables a driver to confirm the situation forward of the car by the sharp image output.

There is a DSP 11 for processing the electric charge for every pixel that can read out the electric charge of not only the single pixel but also a lump of some pixels, in the ODD fields and the EVEN fields.

In the embodiment, although the output image is designed to be displayed on the headup display 9, it can be displayed on a display provided inside the car. Further, although the forward direction of the car in the running direction is illuminated by the IR lamp 3, the rear or the lateral side may be illuminated.

As the double exposure control to be switched, a simple double exposure control and a double exposure control of the other format can be adopted, besides the above double exposure control.

The imaging system may be adopted to not only a car but also a two-wheeled vehicle, a marine vessel, and the other transport, or it may be formed as an imaging system independent of the transport.

What is claimed is:

1. An imaging system comprising:
infrared ray illuminating means for radiating an infrared ray;
imaging means for taking an image of a place illuminated by the infrared ray illuminating means and converting the image into an electric signal; and
an image processor switchable between an automatic exposure control for continuously and periodically supplying images of same light exposure amount at a predetermined cycle of signal accumulating time of the imaging means and a double exposure control for varying the signal accumulating time of the imaging means at a predetermined cycle and continuously and periodically supplying images of different light exposure amount, wherein
the image processor switches the automatic exposure control and the double exposure control depending on a state of intensity of the image.

2. The imaging system, according to claim 1, wherein
the image processor switches the automatic exposure control to the double exposure control when a bright area of the image exceeds an intensity threshold as a reference of a bright image and dimensions of the area exceed an area threshold as a reference of switching.

3. The imaging system, according to claim 1 or 2, wherein
in the double exposure control, the image processor vertically extends the images of different light exposure amount and averages signal levels of the both extended images, thereby forming a composite image.

4. The imaging system, according to claim 3, wherein
the image processor inserts an average value of the signal levels of vertically adjacent pixels between the both pixels, thereby extending the images.

5. The imaging system, according to one of claims 1 to 4, wherein
the infrared ray illuminating means, the imaging means, and the image processor are provided in a car,
the infrared ray illuminating means illuminates an outside of the car with the infrared ray, and
the imaging means takes an image of the outside of the car.
